(19) United States
(12) Patent Application Publication
(10) Pub. No.: US 2022/0331821 A1
(43) Pub. Date: Oct. 20, 2022

(54) SHOWERHEAD ASSEMBLY WITH SEQUENTIALLY PULSING NOZZLE SETS

(71) Applicant: ETL, LLC, Sparks, NV (US)

(72) Inventor: David Hofman, Reno, NV (US)

(21) Appl. No.: 17/855,544

(22) Filed: Jun. 30, 2022

Related U.S. Application Data
(63) Continuation-in-part of application No. 17/061,178, filed on Oct. 1, 2020, now Pat. No. 11,376,614.

(51) Int. Cl. B05B 3/04; B05B 1/18; B05B 1/16

(52) U.S. Cl. CPC B05B 3/04; B05B 1/18; B05B 1/1645

(57) ABSTRACT

A showerhead assembly is provided which includes an outer housing and inner housing. The inner housing includes a support disk and gear housing disk for housing a selector wheel having a slot. The outer housing includes the base and a faceplate having nozzle systems connecting to complementary orifices. Water enters the internal housing via a channel where it is further diverted by the diverter arms so as to impinge on a gear train's bladed rotor, causing the gear train's individual components to rotate. Upon the rotation of the selector wheel, the selector wheel's slot aligns with a selected orifice whereby water travels through and enters a corresponding nozzle system. This sequence continues, causing water to sequentially spray from individual nozzles in systematic intervals so as to create a strobe-like spray pattern.

### RELATED APPLICATIONS

The present application is a continuation-in-part of U.S. patent application Ser. No. 17/061,178 filed Oct. 1, 2020.

### BACKGROUND OF THE INVENTION

The present invention relates to showerheads. More particularly, the present invention relates to showerheads having multiple nozzle sets that release water at varying intervals so as to produce a pulsing effect on the emitted water.

Showerheads are commercially available in numerous designs and configurations for use in showers, faucets, spas, sprinklers and other personal and industrial systems. The vast majority of showerheads include spray heads which may be categorized as being either stationary or oscillating and have either fixed or adjustable openings. Stationary spray heads with fixed jets are the simplest constructions consisting essentially of a central conduit connected to one or more spray nozzles directed to produce a constant pattern. The stationary spray showerheads cause water to flow through the construction to contact essentially the same points on a user's body in a repetitive fashion.

Multifunction showerheads are able to deliver water in many different spray patterns such as a fine spray, a coarse spray, or a pulsating spray. Of course, many other spray patterns may also be provided.

Moreover, many showerhead assemblies allow users to manipulate spray nozzles into various positions and alignments so as to assist in the cleaning process. Advantageously, some showerhead assemblies include spray nozzles having control mechanisms that allow the user to manipulate water flow so as to choose a desired spray pattern. For example, U.S. Pat. No. 5,433,384 discloses a handheld showerhead that produces a pulsating spray pattern by way of a push button attached to a pawl bearing against a ratchet wheel. Further, this showerhead includes a rotating turbine having a flange and openings, wherein rotation of the turbine causes the openings to align with conduits so as to cause nozzles to periodically pulse water. However, this construction requires user intervention and a push-button mechanism in order to yield a pulsating spray pattern.

Additionally, U.S. Pat. No. 4,588,130 describes a showerhead that produces a pulsating spray pattern by way of three different passageways and a vaned rotating member having a partial plate and an open side. Specifically, as the plate rotates, it aligns with and selectively blocks a given conduit. Meanwhile, the rotating member's opening is exposed to nozzle outlets, whereby water passes from the openings through the outlets in order to produce a water in a pulsating fashion. However, this reference discloses a showerhead assembly having only one showerhead housing.

Similarly, U.S. Pat. No. 5,215,258 discloses a showerhead having a rotating mechanism that produces a pulsating spray pattern. Importantly, this showerhead housing includes a gear system having a rotor integrated into a dial so as allow rotation as a unit when the gear system is impinged by water.

Though these references both describe a showerhead which provide a housing system having a rotating mechanism and pulsing capability, neither specify a particular mechanism having an outer housing and inner housing with the necessary gear train assembly, including but not limited to the inclusion of diverter arms, that would produce a strobe effect on the emitted water. Additionally, none of these references describe a gear mechanism that operates as a unit with a set of nozzle conduits and nozzle outlets designed to release water in sequenced intervals so as to produce a strobe-effect.

Thus, it would further be advantageous to provide a showerhead assembly that included a primary showerhead having two housings functioning as a unit in order to release water in periodic, patterned intervals so as to create a strobe spray pattern.

Further, it would be advantageous to provide a showerhead assembly that included a plurality of nozzle conduits and a corresponding number of nozzle outlet sets that are selectively blocked and unblocked by the inner housing mechanism, thereby releasing water in a rhythmic fashion without user intervention so as to enable the user to create a unique shower experience.

### SUMMARY OF THE INVENTION

Briefly, in accordance with the invention, an improved water spraying assembly is provided which includes an outer housing and inner housing working as constituent parts. The inner housing includes two disks: a support disk and a gear housing disk. Further, the inner housing comprises an internal cavity bearing a gear train assembly. Additionally, the outer housing includes the showerhead housing base, wherein the inner housing resides, and a circular showerhead faceplate, constituting the outermost portion of the showerhead assembly, thereby covering the inner housing portions. Specifically, the showerhead faceplate includes a plurality of nozzle systems wherein each nozzle system includes a duct formed into the faceplate's backside which extends to one or more nozzles which project through the faceplate to the faceplate's front side. The water spraying assembly has particular application for use within a showerhead. Accordingly, the preferred water spraying assembly is described as a showerhead assembly.

The primary showerhead can be relatively traditional in construction including a showerhead housing base connected to a water source by a neck portion. Additionally, the neck portion includes a conduit having an inlet threadably affixed to a water source pipe. The inlet is in fluid connection with the pipe so as to receive water from it and allow such water to travel through showerhead housing base into the nozzle systems for ejection. Various showerhead housing bases and conduit constructions can be determined by those skilled in the art.

Preferably, the showerhead housing base is frustoconical in shape. The support disk, which forms the inner layer of the showerhead's inner housing side, is affixed to and secured onto the gear housing disk whereby it forms its support cover. Further, the gear housing disk is directly adjacent to and works in conjunction with the outer housing's showerhead faceplate.

The anterior of the gear housing disk, which is the side of the disk affixed to the support disk, includes an internal cavity with a gear train. Specifically, the nucleus of the gear housing disk's inner layer is concaved so as to house the internal cavity bearing the gear train. In the preferred embodiment, the internal housing is cuboid shaped. In a one embodiment, the internal cavity includes a water channel, two diverter arms, and a gear train. Additionally, the posterior of the gear housing disk, which is the side attached to the showerhead faceplate, includes a plurality of similarly shaped window slits. In a preferred embodiment, the gear housing disk includes four window slits that are trapezoidal in shape.

In the first preferred embodiment, the conduit's inlet collects water from the water source and empties such water into the internal cavity's water channel that is in fluid connection with the gear train. Specifically, the water channel includes a first end that is in fluid connection with the conduit's inlet and a second end that is in fluid connection with the gear train. The gear train includes three-wheel portions: a bladed rotor, pinion, and a selector wheel. In this embodiment, the selector wheel takes the form of a large gear. More specifically, the water received by the water channel flows through the bladed rotor portion of the gear train, whereby such water flow causes the bladed rotor to rotate in a counterclockwise direction. The bladed rotor, which may be a propeller or impeller, is directly below and coupled with the pinion, continues to rotate as water passes through, thereby causing the pinion to rotate in a clockwise direction. Additionally, the pinion, which is meshed with the large gear, causes the large gear to revolve in a clockwise direction as water flows from the rotating pinion portion and passes through the large gear.

Importantly, two diverter arms are positioned to divert water and are located adjacent to the bladed rotor's blades, thereby functioning as a driving force to propel water through the gear train. Specifically, the first diverter arm projects from the internal cavity and is directly adjacent to the second end of the water channel and left of the bladed rotor so as to direct the water flow through the internal cavity. Additionally, the second diverter arm project from the internal cavity and resides beneath the large gear, bordering the bladed rotor's right side. This second diverter arm directs water from the bladed rotor to one side of the large gear.

Further, the large gear includes one slot similarly shaped and sized to the gear housing disk's window orifices. Upon rotation of the large gear, the large gear's slot aligns with one of the window slits so as to create an open passageway by which water flows through. The showerhead faceplate comprises nozzle systems including nozzle ducts having nozzle outlet sets. Additionally, the nozzle systems are positioned so as to be in alignment with the gear housing disk's window orifices. The showerhead faceplate remains static in position as the gear housing disk's gear train revolves in response to water flowing through its internal cavity. Accordingly, as water travels from the large gear's slot and through the window orifice to which it aligns with, such water then exits from the window orifice into a complementary nozzle system. Water continues to flow through the nozzle system's duct and is emitted through the nozzle's respective nozzle outlet set in intervals. Water continues to sequentially be released from the outlets as such water flows continuously impinges the gear train and passes through the internal cavity, ultimately exiting through alternating nozzle outlet sets. Specifically, and as a consequence of the water selectively exiting through varying nozzle outlet sets, the user experiences a strobe-like water spray pattern.

In an alternative embodiment, the gear train includes only the selector wheel. Like the first embodiment, the selector wheel includes one slot similarly shaped and sized as the gear housing disk's window orifices. However, instead of including a separate bladed rotor to rotate the selector wheel, the selector wheel integrates a bladed rotor into its construction. More specifically, for this embodiment, the selector wheel's periphery includes a plurality of blades so that the selector wheel forms a propeller or impellor. As water enters the gear housing, the water rotates the selector wheel, and upon rotation of the selector wheel, the selector wheel's slot aligns with one of the window slits so as to create an open passageway by which water flows through to exit through alternating nozzle outlet sets.

Thus, it is an object of the present invention to provide a spray head assembly having an improved nozzle strobe spray pattern capability compared to previous showerheads.

Furthermore, it is an additional object of the present invention to provide a spray head assembly having an improved construct so as to generate a strobe effect on the spray pattern without relying on user intervention and instead depending on two housing structures working in conjunction with each other.

Other features and advantages of the present invention will be appreciated by those skilled in the art upon reading the detailed description which follows with reference to the Drawings.

### BRIEF DESCRIPTION OF THE DRAWINGS

These and other, further and more specific objects and advantages of the invention will be apparent to those skilled in the art from the following detailed description thereof, taken in conjunction with the Drawings, in which:

FIG. 1 is a left perspective view of the showerhead assembly wherein the showerhead faceplate includes four nozzle outlet sets;

FIG. 2 is a front cutaway view of the showerhead assembly illustrated in FIG. 1 wherein the showerhead faceplate superimposes the gear housing disk, illustrating the flow of water entering the water channel and impinging on the gear train's bladed rotor;

FIG. 3 is a left cutaway view of the showerhead assembly illustrated in FIG. 1 illustrating the flow of water from the conduit through the gear train assembly, wherein the gear slot is not aligned with a window orifice, thereby preventing water from passing through a nozzle system;

FIG. 4 is a left perspective view of the showerhead assembly illustrated in FIG. 1 wherein one of the four nozzle outlet sets is expelling water;

FIG. 5 is a front cutaway view of the showerhead assembly illustrated in FIG. 1 illustrating the large gear rotating, thereby causing the large gear's slot to align with the window orifice overlapping the bottom nozzle system;

FIG. 6 is a left cutaway view of the showerhead assembly illustrated in FIG. 1 illustrating the flow of water from the conduit through the gear train assembly, wherein the gear slot is aligned with a window orifice, thereby allowing water to pass through the nozzle system and eject out of its respective nozzle outlet;

FIG. 7 is a left exploded backside view of the gear housing disk for the showerhead assembly illustrated in FIG. 1, illustrating the arrangement by which the three wheel portions are mounted onto the internal housing structure so as to allow the gear train to rotatably pivot;

FIG. 8 is a left backside view of the gear housing disk for the showerhead assembly illustrated in FIG. 1, illustrating the layout of the gear train parts on the internal housing structure residing on anterior of the gear housing disk;

FIG. 9 is a left exploded side view of the showerhead assembly illustrated in in FIG. 1, illustrating the individual outer housing and inner housing components and their respective orientations within the showerhead assembly system;

FIG. 10A is a left perspective view of the showerhead assembly illustrated in FIG. 1 wherein the showerhead faceplate's lower quadrant nozzle outlet set is projecting water;

FIG. 10B is a left perspective view of the showerhead assembly illustrated in FIG. 1 wherein the showerhead faceplate's left quadrant nozzle outlet set is projecting water;

FIG. 10C is a left perspective view of the showerhead assembly illustrated in FIG. 1 wherein the showerhead faceplate's upper quadrant nozzle outlet set is projecting water;

FIG. 10D is a left perspective view of the showerhead assembly illustrated in FIG. 1 wherein the showerhead faceplate's right quadrant nozzle outlet set is projecting water;

FIG. 11 is a left exploded backside view of a second embodiment of the gear housing disk for the showerhead assembly wherein the selector wheel includes an impellor construction;

FIG. 12 is a left non-exploded backside view of the gear housing disk shown in FIG.11;

FIG. 13 is a left exploded side view of the second embodiment of the showerhead assembly including the gear housing disc shown in FIGS. 11; and

FIG. 14 is a left cutaway view of the showerhead assembly illustrated in FIG. 13 illustrating the flow of water from the conduit through the selector wheel, wherein the selector wheel slot is aligned with a window orifice, thereby allowing water to pass into a nozzle system.

### DETAILED DESCRIPTION OF THE INVENTION

While the present invention is susceptible of embodiment in various forms, as shown in the Drawings, hereinafter will be described the presently preferred embodiments of the invention with the understanding that the present disclosure is to be considered as an exemplification of the invention, and it is not intended to limit the invention to the specific embodiments illustrated.

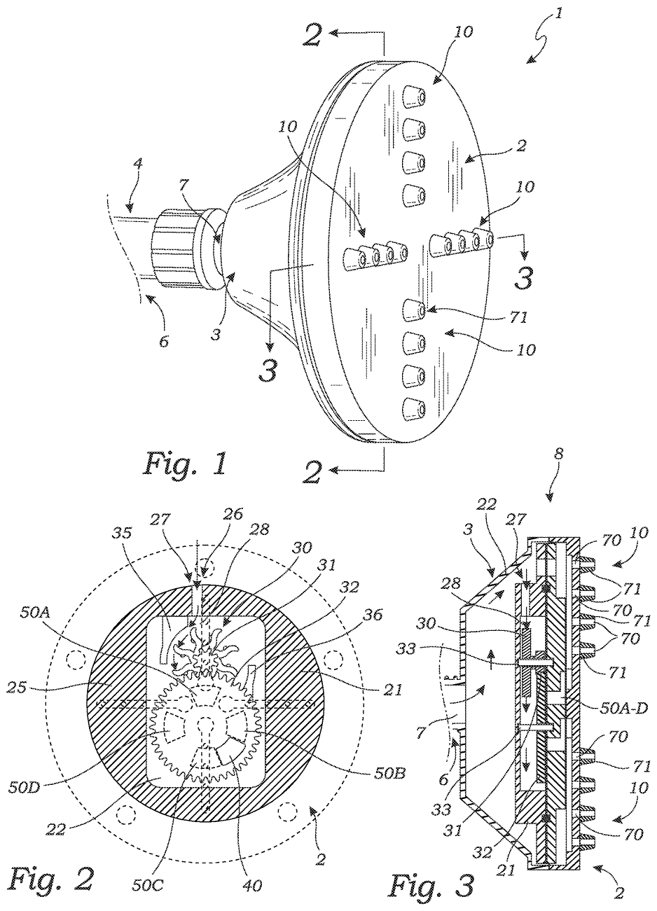

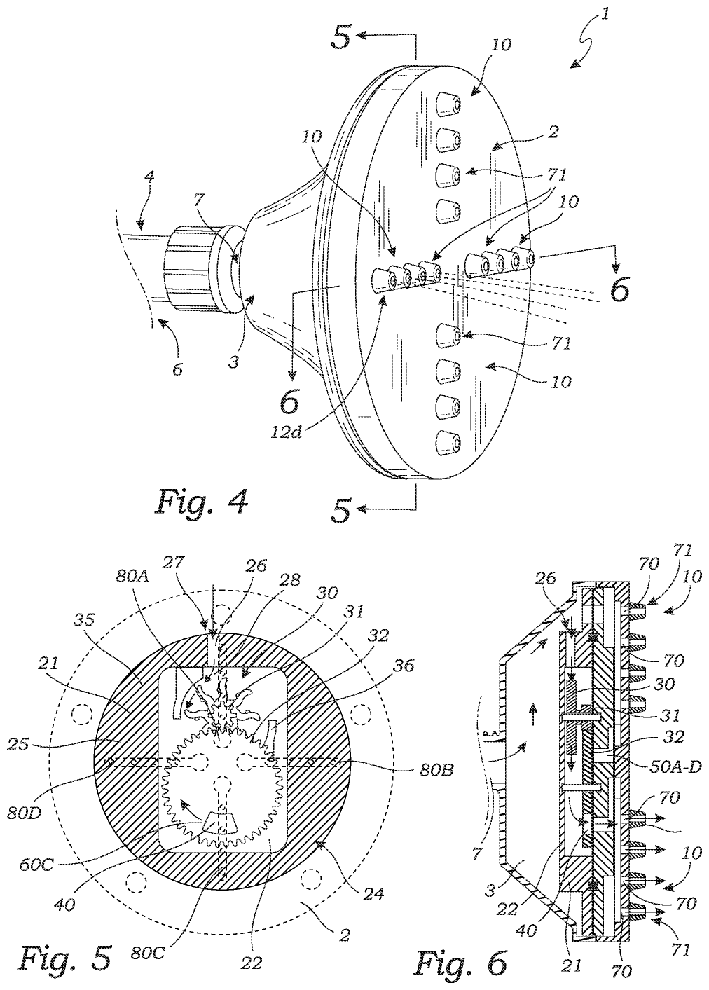

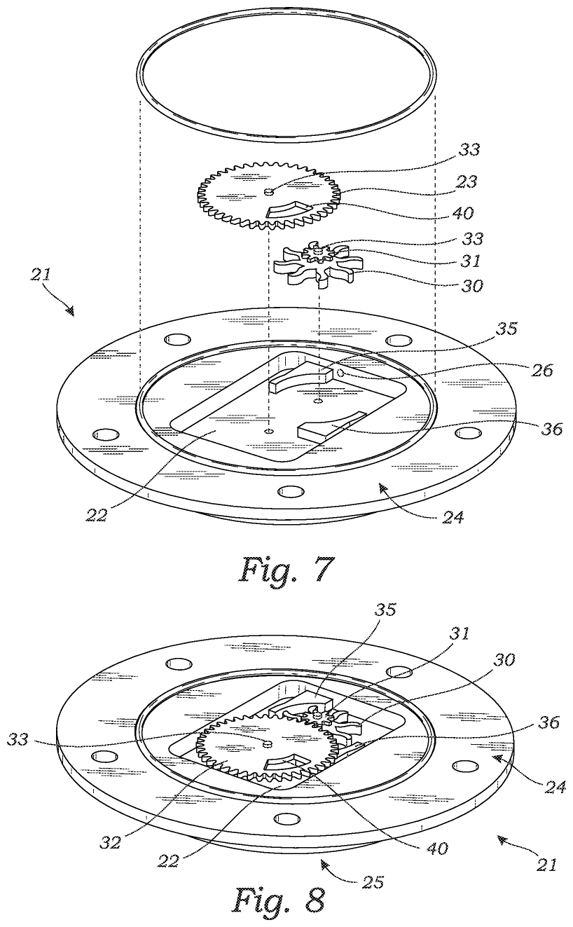

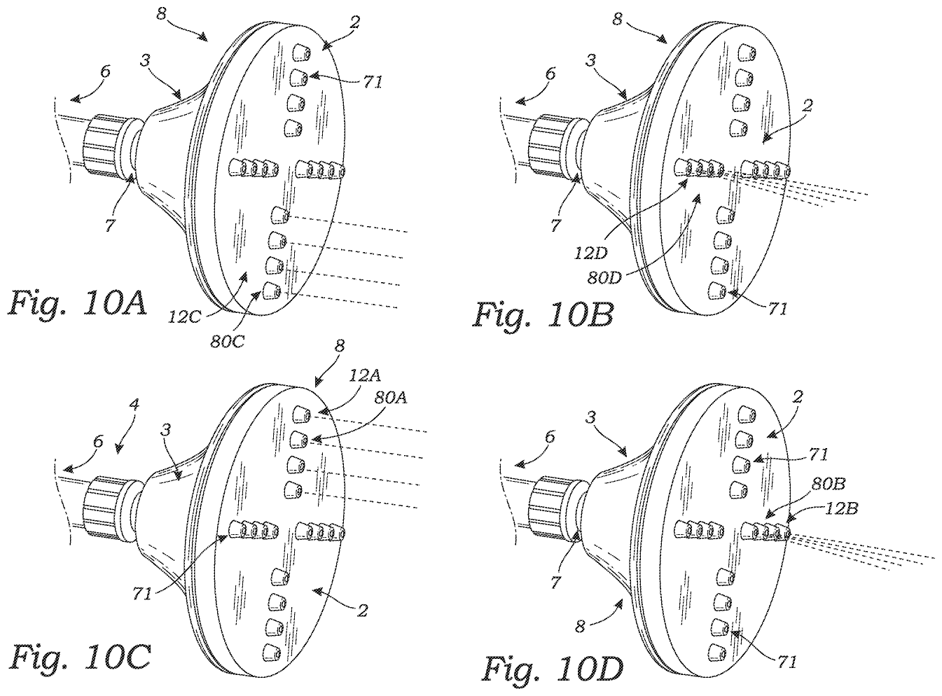

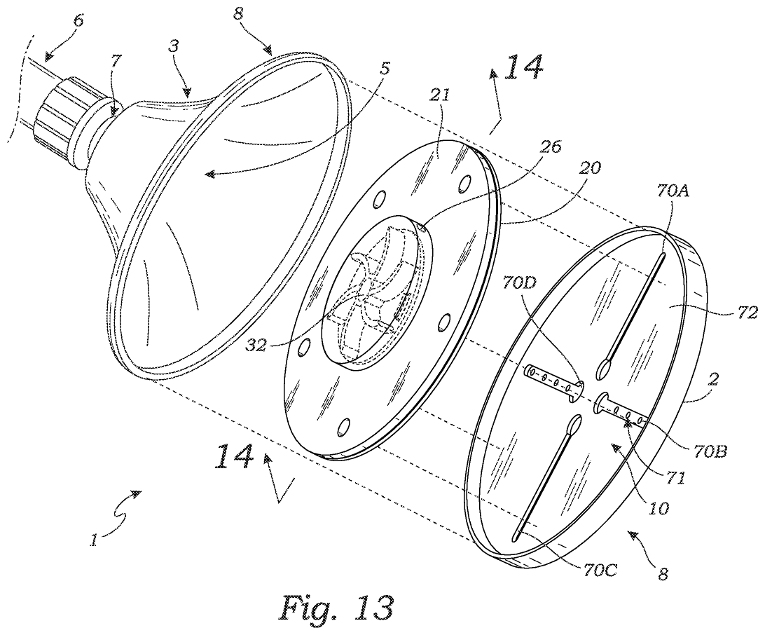

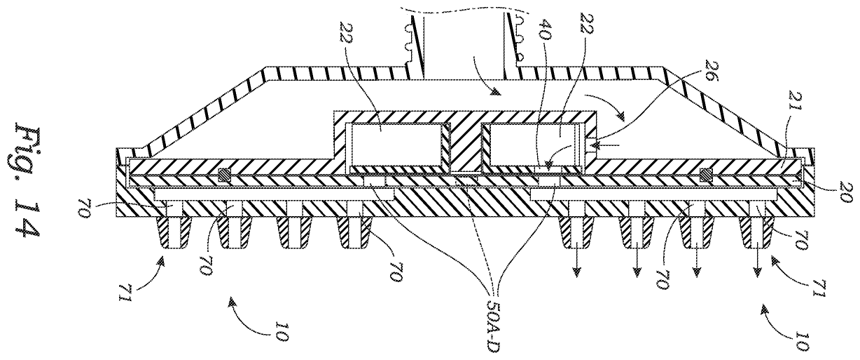

With reference to FIGS. 1-14, the water spraying assembly of the present invention is illustrated as a showerhead assembly 1 which includes an outer housing structure 8 and inner housing structure 9. Preferably, the outer housing structure 8 comprises the showerhead housing base 3 and the showerhead faceplate 2 having four nozzle systems 12A-D. Even more preferably, the inner housing structure 9 includes two primary components: a support disk 20 and a gear housing disk 21. In addition, the inner housing structure 9 further comprises an internal cavity 22 between the support disk 20 and gear housing disk 21 wherein a gear train 23 resides and works as a unit with a plurality of nozzle systems 12A-D. As would be understood by those skilled in the art, the showerhead assembly may include any number of nozzle systems 12A-D. However, for explanation purposes and with reference to FIGS. 10A-10D, a preferred showerhead assembly is described herein as having four nozzle systems 12A-D.

The four nozzle systems 12A-D are incorporated onto the outer housing's circular showerhead faceplate 2 which covers the posterior portion 25 of the inner housing's gear housing disk 21. Even more specifically, the showerhead faceplate's four nozzle systems 12A-D include four ducts 70 formed into the faceplate's back side 72 which extend to the four nozzle outlet sets 71. Preferably, the various nozzle outlet sets 71 emit water in an alternating fashion so as to create a strobe-effect on the spray pattern and provide a more unique shower experience for the user.

Preferably, the showerhead assembly 1 includes a showerhead housing base 3 that is frustoconical in shape. Even more preferably, the showerhead assembly 1 includes a neck portion 4 which houses the conduit 5 and is connected to a water source 6. Further, the conduit 5 includes an inlet 7 threadably affixed to the water source pipe. The inlet 7 receives water from the water source 6 and transports such water to the internal housing structure's water channel 26 so as to convey such water to the nozzle systems 12A-D. The water channel 26 includes a first end 27 and second end 28. Specifically, the first end 27 is in fluid connection with the conduit's inlet 7 and the second end 28 is in fluid connection with the gear train 23, so as to facilitate the passage of water from the conduit 5 through the cavity 22.

In an illustrative embodiment, the inner housing 9 comprises a support disk 20 which is affixed to and secured onto the gear housing disk 21, thereby functioning as a support structure for the gear housing disk 21. The gear housing's posterior side 25 converges with the outer housing of the showerhead faceplate 2.

Additionally, the gear housing disk 21 includes an anterior side 24 and posterior side 25. Moreover, the anterior side 24 includes an internal cavity 22 having a gear train 23. Preferably, the internal cavity 22 is cuboid shaped. More preferably, the internal cavity 22 resides within the depressed nucleus of the gear housing disk's anterior side 24. The gear housing disk's posterior portion 25 is embedded with four sets of similarly shaped window orifices 50A-D. In the preferred embodiment, the four sets of window orifices 50A-D are trapezoidal in shape. In the even more preferred embodiment, the window orifices' 50A-D axes are parallel to or the same as the gear train's 23 axis. Further, each window orifice 50A-D is equidistant from neighboring window orifices 50A-D and reside separately within each of the large gear's four quadrants 60A-D. For example, window orifice 50A is embedded in large gear's quadrant 60A, window orifice 50B is embedded in large gear's quadrant 60B, window orifice 50C is embedded in large gear's quadrant 60C, and window orifice 50D is embedded in large gear's quadrant 60D. The window orifices 50A-D are configured so as to align in a complementary fashion with the four nozzle systems 12A-D embedded on the showerhead faceplate 2. For example, window orifice 50A is configured to align with nozzle system 12A, window orifice 50B is configured to align with nozzle system 12B, window orifice 50C is configured to align with nozzle system 12C, and window orifice 50D is configured to align with nozzle system 12D.

In a first embodiment illustrated in FIGS. 1-10, the gear train 23 includes three-wheel portions: a bladed rotor 30, pinion 31, and a slotted large gear 32. In the embodiment illustrated in FIGS. 2-3 and FIGS. 5-8, the bladed rotor 30 is a propeller. However, the bladed rotor may be any circular structure having blades and capable of being turned by the flow of water such as propeller, impellor or water wheel. Specifically, water flows through the water channel 26 upstream from the gear train 23 and passes through the bladed rotor 30, thereby causing the bladed rotor 30 to rotate in a counterclockwise direction. Even more specifically, the pinion 31 is meshed and oriented above the bladed rotor 30 so as to rotate in a clockwise direction upon counterclockwise rotation of the bladed rotor 30. Additionally, the large gear 32 is sufficiently in contact with the pinion 31 so as to gain momentum by its slight collision with the pinion 31 upon the pinion's 31 rotation. Specifically, the large gear 32 revolves in a clockwise direction as the pinion 31 rotates and water continues to impinge and flow through the entirety of the gear train 23.

In the first embodiment, the three-wheel portions are mounted by arbors 33 onto the internal cavity 22 so as to allow the gear train 23 to rotatably pivot as water passes through the compound gear mechanism. Moreover, the internal housing structure's 22 axis is parallel to or the same as the gear train's 23 axis. Preferably, the bladed rotor's 30 diameter is one half of the large gear's 32 diameter. Even more preferably, the bladed rotor's 30 diameter is one third of the large gear's 32 diameter so as to produce optimal water torque and speed.

As illustrated in FIGS. 5-8, the internal cavity 22 includes two diverter arms 34 that function as driving forces to propel water through the gear train 23. Accordingly, the diverter arms 34 are in fluid connection with the bladed rotor's 30 teeth and are positioned so as to optimally divert water flow. Specifically, the first diverter arm 35 is erected from the internal cavity 22 and is directly adjacent to the water channel's second end 28 and to the bladed rotor's 30 left side. Additionally, the second diverter arm 36 is erected from the internal cavity 22 and resides beneath the large gear 32, bordering the bladed rotor's 30 right side. This methodical configuration allows the diverter arms 34 to appropriately direct and modulate water flow through the internal cavity 22.

Moreover, the large gear 32 includes one slot 40 configured similarly to the window orifices 50A-D on the gear housing disk's posterior side 25 and resides along the same axis. Preferably, the slot 40 is the same shape and size as the window orifices 50A-D so as to allow the slot 40 to align with one window orifice 50A-D upon rotation of the large gear 32, thereby causing water to travel through the opening and exit the gear housing disk 21. The gear housing disk 21 is parallel and appended to the showerhead faceplate 2 in a manner which allows for water to be received via the nozzle ducts 70 and emit out of the nozzle outlets 71.

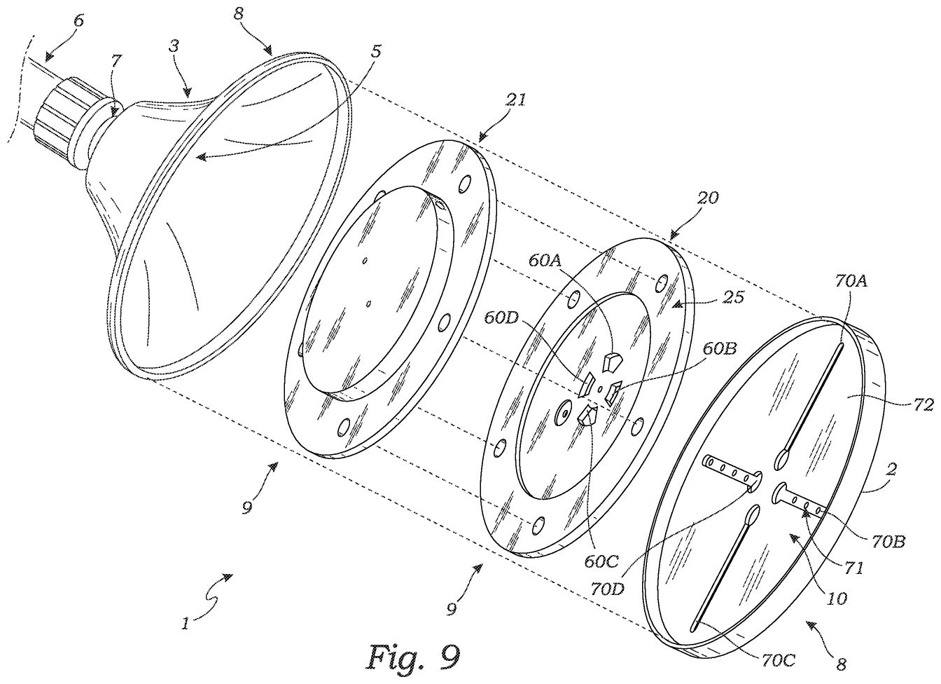

Specifically, the showerhead faceplate 2 comprises four nozzle systems 12A-D. Each nozzle system 12A-D includes a nozzle duct 70 having four nozzle outlets 70. In the preferred embodiment, the four nozzle systems 12A-D are configured in a spatially equidistant manner from neighboring nozzle systems 12A-D. Preferably, and as illustrated in FIGS. 9 and 10, one nozzle system 12A-D resides per each quadrant of the showerhead's faceplate 80A-D. For example, nozzle system 12A resides in showerhead faceplate's quadrant 80A, nozzle system 12B resides in showerhead faceplate's quadrant 80B, nozzle system 12C resides in showerhead faceplate's quadrant 80C, and nozzle system 12D resides in showerhead faceplate's quadrant 80D. Even more preferably, the nozzle ducts 70 are recessed within the showerhead's faceplate 2 while the nozzle outlets 71 project out of the showerhead's faceplate 2. Even more preferably, the nozzle ducts 70 are arranged directly above and adjacent to corresponding window orifices 50A-D on the gear housing disk 21. This configuration allows water received by the window orifice 50A-D to pass through a given nozzle duct 70 and project out of its respective nozzle outlets 71. Notably, the nozzle ducts 70 remain static in position as the gear train 23 revolves in the internal cavity 22. Water is received by a nozzle system 12A-D only upon alignment of the system's respective nozzle duct 70 with the large gear's slot 40. The gear train 23 functions as a unit with the nozzle systems 12A-D, selectively spraying water in consecutive intervals upon revolution of the large gear 32. Accordingly, each nozzle outlet 70 ejects water successively and rhythmically so as to create a strobe-effect spray pattern for the user.

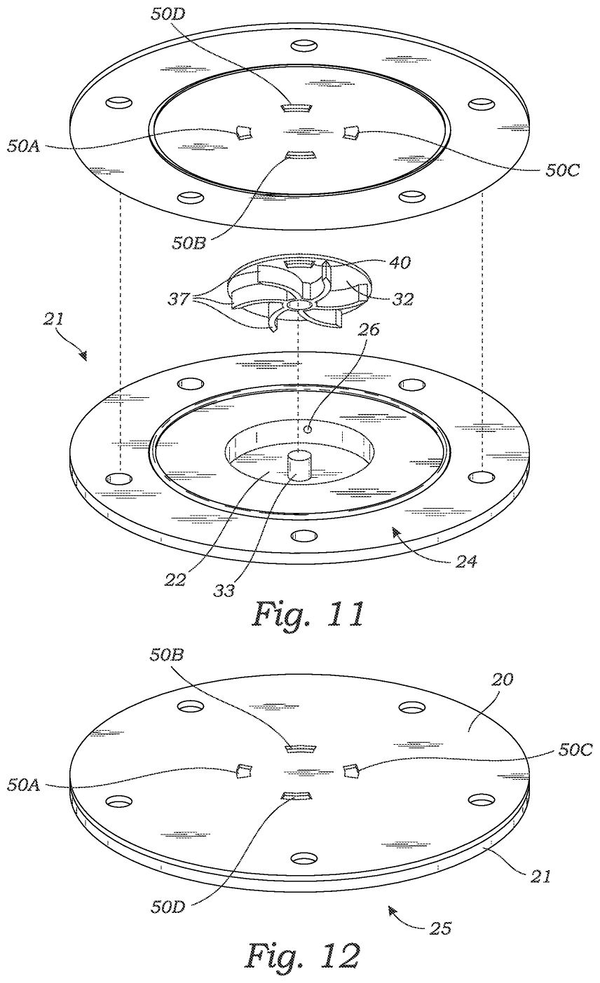

In a second embodiment illustrated in FIGS. 11-14, the gear train includes only the selector wheel 32 which includes a plurality of blades 37 to form an impellor. Like the previous embodiment, the selector wheel 32 is rotatable upon an arbor 33 and includes a slot 40 having a shape that is the same or similar to the window orifices 50A-D in the support disk 21 so as to allow the slot 40 to align with one window orifice 50A-D upon rotation of the large gear 32.

Again, water flows through the water channel 26 into cavity 22 to pass through the selector wheel's blades 37. Water striking the blades 37 causes the selector wheel 32 to rotate. As the selector wheel 32 rotates, the selector wheel's slot 40 will selectively and sequentially align with one of the window orifices 50A-D to allow water pass to through a given nozzle duct 70 to sequentially spray out of its respective nozzle outlets 71.

While a preferred nozzle set and showerhead assembly 1 have been illustrated and described, it would be apparent that various modifications of the nozzle set and showerhead assembly 1 can be made without departing from the spirit and scope of the invention. Accordingly, it is not intended that the invention be limited except by the following claims. Having described my invention in such terms to enable a person skilled in the art to understand the invention, recreate the invention, and practice it, and having identified the presently preferred embodiments thereof, I claim:

1. A water spraying assembly comprising:
a female threaded inlet to threadably engage a male threaded pipe of a water source;
a longitudinally extending central conduit for the passage of water having a first end, a body, and a second end, said central conduit's first end connected to said female threaded inlet for receiving water, said central conduit's body for conveying such water from said first end to said second end, and said second end forming said central conduit's outlet to expel water;
an outer housing comprising a showerhead housing base and a showerhead faceplate having a front side, a back side and a plurality of nozzle systems, each of said nozzle systems including a duct formed into said faceplate's backside which extend to nozzles which extend through said faceplate to said faceplate's front side;
an inner housing residing within said outer housing, said inner housing comprising an anterior side and posterior side and a gear housing disk having an anterior side and posterior side, said gear housing disk's anterior side includes an internal housing having a water channel and a selector wheel, said selector wheel having a center about which said selector wheel rotates and one slot providing a passageway by which water received by said selector wheel can pass through, said slot offset from said center of said selector wheel so as to rotate about said center with the rotation of said selector wheel, and said gear housing's posterior side includes a plurality of orifices with each of said orifices in fluid communication with one of said faceplate ducts, said large toothed gear engaging said gear housing posterior side and obstructing said plurality of orifices so as to prevent water within said inner housing to flow through said plurality of orifices unless said large toothed gear's slot aligns with one of said orifices which allows water within said inner housing to flowing through said slot to a corresponding one of said orifices, and then through a corresponding one of said ducts to be emitted from corresponding nozzles; and
said selector wheel is positioned to rotate as water enters said inner housing to cause said selector wheel to sequentially release water through said offset slot to said nozzles in periodic intervals dependent on a revolution of said selector wheel.

2. The water spraying assembly of claim 1 wherein said gear housing's posterior side includes four orifices and said faceplate includes four nozzle systems.

3. The water spraying assembly of claim 1 wherein said selector wheel is a large toothed gear, and said gear housing disk's anterior side further includes a bladed rotor and a toothed pinion extending co-axially from said bladed rotor, and said pinion is in toothed engagement with said selector wheel,

4. The water spraying assembly of claim 3 wherein said bladed rotor is a propeller.

5. The water spraying assembly of claim 1 wherein said selector wheel is a bladed rotor in the form of an impellor.
